(19) United States
(12) Patent Application Publication
(10) Pub. No.: US 2025/0256786 A1
(43) Pub. Date: Aug. 14, 2025

(54) Ultra-thin embedded rigid cover without joints

(71) Applicant: Yunyan He, Hangzhou (CN)

(72) Inventors: Shaoyong Zheng, Hangzhou (CN); Yunyan He, Hangzhou (CN)

(21) Appl. No.: 18/640,410

(22) Filed: Apr. 19, 2024

(30) Foreign Application Priority Data
Feb. 9, 2024 (CN) 202410178482.3

(51) Int. Cl. B62D 33/04

(52) U.S. Cl. CPC B62D 33/044

(57) ABSTRACT

The present invention discloses an ultra-thin embedded rigid cover without joints, including a side rubber strip, a guide rail system, a clamp system, a fixing lock bolt, a plurality of cover plates and a plurality of soft rotating shafts. The cover plate includes a front plate, a first intermediate plate, a second intermediate plate and a small plate, the front plate and the first intermediate plate, the first intermediate plate and the second intermediate plate, the second intermediate plate and the small plate are all connected to each other by a soft rotating shaft, the soft rotating shaft is of flexible material or of a material combining flexibility and rigidity.

### CROSS-REFERENCE TO RELATED APPLICATIONS

The application claims priority of Chinese patent application CN202410178482.3, filed on Feb. 9, 2024, which is incorporated herein by reference in its entireties.

### TECHNICAL FIELD

This invention is relevant to automotive spare parts, especially an ultra-thin embedded rigid cover without joints.

### BACKGROUND TECHNOLOGY

Pickup trucks have both car-like comfort and strong power, due to the pickup truck's strong ability to carry cargo and adapt to poor road surface, its comprehensive performance also makes it become one of the common off-road models nowadays.

In order to make the pickup truck adapt to more diverse environments, most of the existing pickup trucks are required to be installed with a cover, which currently consists of a hard cover and a soft cover, the soft cover has the specificity of easy fabrication, but it cannot provide good support performance in the process of use and is very easy to be damaged, while the hard cover has strong support performance, but due to the rotating shaft structure in the hard cover, the existing hard cover cannot be made very thin.

### About the Invention

To overcome the deficiencies of the prior art, the present invention provides a tri-fold semi-embedded cover of a front bar with a front extension panel, by changing the connecting structure of the front bar, to solve the above problem.

In order to solve the above problems of the existing technology, the technical solution adopted in the invention is as follows:

An ultra-thin embedded rigid cover without joints, including a side rubber strip, a guide rail system, a clamp system, a fixing lock bolt, a plurality of cover plates and a plurality of soft rotating shafts, with a gap between two adjacent cover plates.

The cover plate includes a front plate, a first intermediate plate, a second intermediate plate and a small plate, the front plate and the first intermediate plate, the first intermediate plate and the second intermediate plate, the second intermediate plate and the small plate are all connected to each other by a soft rotating shaft, the soft rotating shaft is of a flexible material or a material combining flexibility and rigidity, the front plate, the first intermediate plate, the second intermediate plate, the small plate and the soft rotating shaft are all connected to a side rubber strip at both ends, the soft rotating shaft is provided with an intermediate connecting bubble, two ends of the front plate, two ends of the first intermediate plate, two ends of the second intermediate plate and two ends of the small plate are connected to a side rail (front plate, intermediate plate and small panels all with corresponding side rails), the side rail is provided with a bonding section, the side rubber strip is provided with a gluing section, the bonding section is bonded to the gluing section;

The fixing lock bolt is arbitrarily connected to the first intermediate plate, the second intermediate plate and the small plate (the arbitrary connection herein means that the fixing lock bolt can be connected to one or more of the above mentioned plates, or it can be arbitrarily connected to any position of the above mentioned plates), the front plate is connected to either a fixing lock bolt or a front plate fixing rod (the front plate can be connected to the fixing lock bolt or the front plate fixing rod, by connecting only one of them, if the front plate fixing rod is connected, it is necessary to arrange the front plate fixing rod on the side of the front plate close to the front of the car, on the other hand. if the fixing lock bolt is connected, the fixing lock bolt is arranged on the side of the front plate close to the tail of the car).

The present invention does not set end caps at both ends of the soft rotating shaft, the soft rotating shaft will be directly connected to a side rubber strip on both sides, which can reduce the thickness of the car cover.

An ultra-thin embedded rigid cover without joints, includes a side rubber strip, a guide rail system, a clamp system, a fixing lock bolt, a plurality of cover plates and a plurality of soft rotating shafts;

The cover plate includes a front plate, a first intermediate plate, a second intermediate plate and a small plate, the front plate and the first intermediate plate, the first intermediate plate and the second intermediate plate, the second intermediate plate and the small plate are all connected to each other by a soft rotating shaft, the soft rotating shaft is of a flexible material or a material combining flexibility and rigidity, the front plate, the first intermediate plate, the second intermediate plate, the small plate and the soft rotating shaft are connected to the a side rubber strip at both ends, the soft rotating shaft is provided with an intermediate connecting bubble, two ends of the front plate, two ends of the first intermediate plate, two ends of the second intermediate plate and two ends of the small plate are connected to a side rail, the side rail is provided with a bonding section, the side rubber strip is provided with a gluing section, the bonding section is bonded to the gluing section;

The fixing lock bolt is arbitrarily connected to the first intermediate plate, the second intermediate plate and the small plate (the arbitrary connection here means that the fixing lock bolt can be connected to one or more of the above mentioned plates, or it can be arbitrarily connected to any position of the above mentioned plates), the front plate is connected to either a fixing lock bolt or a front plate fixing rod (the front plate can be connected to either a fixing lock bolt or a front plate fixing rod, by connecting only one of them, if the front plate fixing rod is connected, it is necessary to arrange the front plate fixing rod on the side of the front plate close to the tail of the car, on the other hand, if the fixing lock bolt is connected, the fixing lock bolt is arranged on the side of the front plate close to the tail of the car); when the car cover is unfolded, the two adjacent cover plates are abutting against each other (the cover plates here include the front plate, the intermediate plate, and the rear bar).

The pressing rod is connected with a resisting rod, the rear pressing rod is connected with a rear bar resisting rod, when the car cover is spread, the two resisting rods are pressed against each other.

An ultra-thin embedded rigid cover without joints, includes a side rubber strip, a guide rail system, a clamp system, a fixing lock bolt, a plurality of cover plates and a plurality of soft rotating shafts, with a gap between two adjacent cover plates;

The cover plates includes a front plate, a second intermediate plate and a small plate, the front plate and the first intermediate plate, the first intermediate plate and the second intermediate plate, the second intermediate plate and the small plate are connected to each other by a soft rotating shaft, the soft rotating shaft is of a flexible material or a material combining flexibility and rigidity, the front plate, the second intermediate plate, the small plate and the soft rotating shaft are all connected to a side rubber strip at both ends, the soft rotating shaft is provided with an intermediate connecting bubble, two ends of the front plate, two ends of the second intermediate plate and two ends of the small plate are connected to a side rail, the side rail is provided with an bonding section, the side rubber strip is provided with a gluing section, the bonding section is bonded to the gluing section;

The fixing lock bolt is arbitrarily connected to the second intermediate plate and the small plate, the front plate is connected to the fixing lock bolt or the front plate fixing rod.

The intermediate plate can be provided in a plurality of ways or only one, depending on the length of the car cover and the number of folded layers.

An ultra-thin embedded rigid cover without joints, includes a side rubber strip, a guide rail system, a clamp system, a fixing lock bolt, a plurality of cover plates and a plurality of soft rotating shafts.

The cover plate includes a front plate, a second intermediate plate and a small plate, the front plate and the second intermediate plate, the second intermediate plate and the small plate are connected to each other by a soft rotating shaft, the soft rotating shaft is a flexible material or a material combining flexibility and rigidity, the front plate, the second intermediate plate, the small plate and the soft rotating shaft are connected to a side rubber strip at both ends, the soft rotating shaft is provided with an intermediate connecting bubble, two ends of the front plate, two ends of the second intermediate plate and two ends of the small plate are connected to a side rail, the side rail is provided with a bonding section, the side rubber strip is provided with a gluing section, the bonding section is bonded to the gluing section.

The fixing lock bolt is arbitrarily connected to the second intermediate plate and the small plate, the front plate is connected to the fixing lock bolt or the front plate fixing rod, whereby two adjacent cover plates are abutting against each other when the cover is unfolded.

An ultra-thin embedded rigid cover without joints, includes a side rubber strip, a guide rail system, a clamp system, a fixing lock bolt, a plurality of covers and a plurality of soft rotating shafts;

The soft rotating shaft includes a first soft rotating shaft and a third soft rotating shaft, the first soft rotating shaft is of a width greater or less than the width of the third soft rotating shaft, the soft rotating shaft is of a flexible material or a material combining flexibility and rigidity;

The cover plate includes a front plate, a second intermediate plate and a small plate, the front plate and the second intermediate plate are connected to each other by a first soft rotating shaft, the second intermediate plate and the small plate are connected to each other by a second soft rotating shaft, the front plate, the second intermediate plate, the small plate and the soft rotating shaft are all connected to a side rubber strip at both sides, the soft rotating shaft is provided with an intermediate connecting bubble, two ends of the front plate, two ends of the second intermediate plate and two ends of the small plate are connected to a side rail, the side rail is provided with a bonding section, the side rubber strip is provided with a gluing section, the bonding section is bonded to the gluing section;

The fixing lock bolt is arbitrarily connected to the second intermediate plate and the small plate, the front plate is connected to the fixing lock bolt or the front plate fixing rod.

An ultra-thin embedded rigid cover without joints, includes a side rubber strip, a guide rail system, a clamp system, a fixing lock bolt, a plurality of covers and a plurality of soft rotating shafts;

The soft rotating shaft includes a first soft rotating shaft and a third soft rotating shaft, the first soft rotating shaft is of a width greater or less than the width of the third soft rotating shaft, the soft rotating shaft is of a flexible material or a material combining flexibility and rigidity;

The cover plate includes a front plate, a second intermediate plate and a small plate, the front plate and the second intermediate plate are connected to each other by a first soft rotating shaft, the second intermediate plate and the small plate are connected to each other by a second soft rotating shaft, the front plate, the second intermediate plate, the small plate and the soft rotating shaft are all connected to a side rubber strip at both sides, the soft rotating shaft is provided with an intermediate connecting bubble, two ends of the front plate, two ends of the second intermediate plate and two ends of the small plate are connected to a side rail, the side rail is provided with a bonding section, the side rubber strip is provided with a gluing section, the bonding section is bonded to the gluing section;

The fixing lock bolt is arbitrarily connected to the second intermediate plate and the small plate, the front plate is connected to the fixing lock bolt or the front plate fixing rod.

Further, the front plate includes a plate body, a front plate side rail, a front plate front bar, a front plate rear bar, a plate body, a front plate support, a front plate buckle, a front plate rubber strip and a front plate fixing rod, the plate body is surrounded by a front plate front bar, a front plate rear bar and two front plate side rails, the front plate side rails are provided with a rear protrusion and a front protrusion, the rear protrusion is connected to the front plate rear bar, the front protrusion is connected to the front plate front bar, the thickness of the plate body is less than or equal to 10 mm, the front bar support, the front bar buckle and the front plate fixing rod are symmetrically connected to the front plate front bar, the fixing lock bolt is connected to the front plate rear bar, the front plate side rail is provided with a side rail bending hook, the side rubber strip is provided with a bending hook section, the bending hook section is used for hooking the side rail bending hook; the front plate is connected to a guide rail system through a front plate fixing rod, the front plate rubber strip is provided with an extension surface and a front plate rubber strip insertion head, the front plate front bar is provided with a front plate front bar groove, the front plate rubber strip insertion head is clamped with the front plate front bar groove, the front plate consists of a plate body surrounded by four frames, wherein the front plate rear bar is used for connecting a soft rotating shaft, the two front plate side rails are used for connecting the side rubber strips and the guide rails, the plate body in the middle serves as a support, by providing a bending hook at the side rubber strips, it can be fitted with the side rails bending hooks to provide a better connecting effect.

Further, the small plate includes a rear bar, a small plate body, a small plate side rail, a small plate front bar and a rear bar rubber strip; the rear bar rubber strip is provided with a rear bar rubber strip hole, a rear bar rubber strip insertion head and a rear bar rubber strip gluing surface, the rear bar is provided with a rear bar profile lower surface and an insertion groove, the rear bar rubber strip insertion head is snapped into the insertion groove, the rear bar rubber strip gluing surface is glued to the rear bar profile lower surface. The structure of the small plate is similar to the structure of the front plate structure, both of which are constituted by a surrounding frame and a small plate body in the centre, similarly, if the rear bar profile is to be mated with the rear bar rubber strip, a corresponding snap together structure needs to be set up, and the rear bar rubber strip is to be provided with rear bar rubber strip holes, which are used to increase the amount of compression.

Further, the side rubber strip is provided with a gluing section, a bending hook section, a groove and a lower pressing and bending surface, the gluing section is used for bonding with the side rail and the intermediate rotating shaft. The groove allows the glue strip to have an automatic downward pressure stress, which can enhance the waterproof effect. The lower pressing and bending surface also serves to increase the degree of downward pressure on the side rubber strip.

Further, the first soft rotating shaft, second soft rotating shaft and third soft rotating shaft are interchangeable, so that the plate is able to be pressed against the front rail support when the cover is flipped and fold. the soft rotating shaft includes an intermediate connecting bubble, a pressing bar, a snap-in head, and a snap-neck section; the small plate front bar includes a pressing rod, a rod groove, a resisting rod, an upper pressing head, a screw-fixing hole, a plate groove, and an upper plane; the pressing bar is provided on the upper side of the upper plane to enhance waterproofing, the snap-in head is clamped with the rod groove, the pressing rod squeezes the snap-neck section in cooperation with the upper pressing head after deformation, the plate groove is used to connect the plate body, the screw fixing holes are used to connect the side rail by screws. The soft rotating shaft is equipped with an intermediate connecting bubble, which increases the expansion and contraction elasticity of the soft rotating shaft, it can also play a very good waterproof effect by connecting the pressing bar with the upper plane. The soft rotating shaft structure can ensure the smoothness of the car cover flipping and folding, and by setting the rod groove and the pressure bar to ensure that the two ends of the soft rotating shaft are stuck in the inside of the rod groove and not easy to fall off, so as to form a stable connection with the car cover.

Further, the fixing lock bolt includes a lock bolt base, a lock bolt cover, a lock bolt, a lock bolt spring steel, a steel wire, a lock bolt cylinder, a spring, and a cylindrical rod, the lock bolt groove is connected to a plate body, both ends of the lock bolt groove is connected to a lock bolt base, the lock bolt base is connected with a lock bolt cover, the lock bolt base is provided with a lock bolt cavity, a spring arrangement compartment and a cylindrical travelling compartment, the lock bolt cavity, the spring arrangement compartment and the cylindrical travelling compartment are mutually connected, the lock bolt includes a sliding block, the sliding block is provided in the lock bolt cavity, the lock bolt cylinder is located within the spring arrangement compartment and the cylinder traveling compartment, one end of the lock bolt cylinder is connected to the sliding block through the lock bolt spring steel, the other end of the lock bolt cylinder is connected to a steel wire, the lock bolt cylinder is sleeved with a spring, the spring is located in the spring arrangement compartment, the lock bolt is connected to a pulling strap, the pulling strap is located in the cylinder travelling compartment, the pulling strap extends out from the lock bolt cover, the lock bolt groove is connected with a steel wire support block, the steel wire passes through the steel wire support block, the lock bolt cover is provided with a steel wire hole, the steel wire passes through the steel wire hole, the cylindrical travelling compartment is connected with two cylindrical rods, the cylindrical rod is used for positioning the pulling strap.

Further, the clamp system includes a left clamp, a right clamp and a T-rod, the left clamp and the right clamp are connected by screws, the T-rod passes through the left clamp and the right clamp, the T-rod is connected with a nut, the left clamp is provided with a waist hole; the right clamp is provided with a threaded hole and a half-waist hole, the screw passes through the waist hole and the screw hole, the T-rod passes through the half-waist hole. the clamp assembly is mainly to connect the guide rail to the hopper, when in use, part of the left clamp extends into the rail groove, while the right clamp is located on the outer side of the hopper, the left clamp and the right clamp are connected by screws to clamp the guide rail to the car body, and then longitudinally connect the T-rod to achieve multi-directional positioning of the left clamp and the right clamp.

Further, the guide rail system includes a guide rail, the guide rail includes a guide rail groove, a lock bolt arcing surface, a guide rail support plane and a rubber strip gluing surface, the lock bolt arcing surface is located on the inner side of the guide rail, the guide rail support plane is located on the outer side of the guide rail; the guide rail support plane includes a support upper surface and a support lower surface, the support upper surface is attached to the lower pressing and bending surface, the first guide rail rubber strip includes a rubber strip top surface and a rubber strip gluing surface, the rubber strip top surface is glued to the support lower surface, the rubber strip gluing surface is glued to the guide rail groove. The lock bolt arching surface is connected to the guide rail groove by a guide rail gluing surface, the guide rail gluing surface is provided with a positioning strip, the guide rail gluing surface is bonded with a second guide rail rubber strip, the second guide rail rubber strip is provided along the positioning strip. As the guide rail is connected to both the cargo hopper and the car cover, the guide rail should not only ensure the stability of the connection, but also have a certain degree of sealing, therefore, it is necessary to set up a number of rubber strips in the guide rail system, in which the first guide rail rubber strips are set on the outer side of the guide rail, the clamping system is loaded with the first guide rubber strips when clamped, so that it can play a good anti-slip effect, the second guide rail rubber strip is set up on the inner side of the guide rail to play a waterproof effect and prevent rainwater from entering the hopper, in addition, the side rail rubber strip is located on the upper side of the guide rail, which also plays a certain waterproof effect.

Further, the guide rail groove is connected to a front plate fixing clamp, the front plate fixing rod includes a threaded rod, one end of the threaded rod is connected to a square head, which is used to clamp with the front plate front plate groove, the threaded rod passes through the front plate fixing clamp and connects to a plum nut and butterfly nut, the front bar fixing clamp includes a front and rear groove, a snap-in notch and a slide-in opening, the slide-in opening is connected to the guide rail groove, the snap-in notch is connected to the front and rear grooves, the snap-in notch and the front and rear grooves are used to connect the threaded rod, the front bar is connected to the guide rail through the front bar fixing clamp, the installation of the front bar fixing clamp ensures the stability of the front bar connection, one end of the front bar fixing clamp is connected to the guide rail, followed by the front plate fixing rod extends into the snap-in notch, and finally the plum nut and butterfly nut are connected to the front plate fixing rod to complete the fixing of the front plate, as the front plate fixing clamp is also provided with front and rear grooves, the front bar fixing rod can be moved back and forth along the front and rear grooves after it is extended into the front and rear grooves, which allows fine-tuned according to the position of the front bar.

The beneficial effects of the present invention are:

1. The present invention makes it possible to make the overall car cover thinner, smaller and lighter by omitting the original rotating shaft joint.

2. The present invention adopts a simple soft rotating shaft structure, which is easier and cheaper than the previous rigid structure, and can be designed to be thinner.

### DESCRIPTION OF FIG

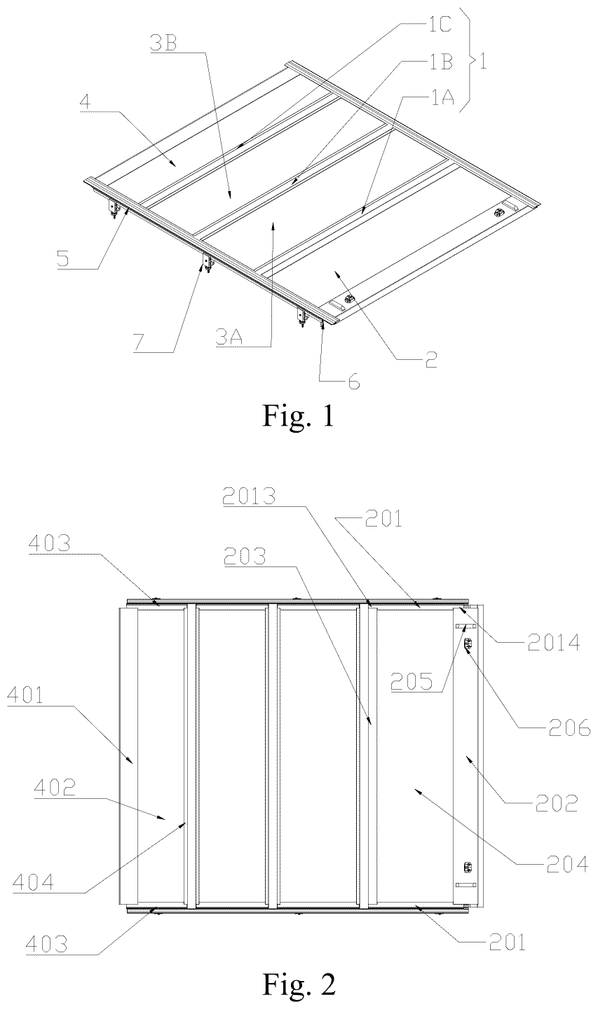

FIG. 1 is a structural schematic diagram I of the present invention.

FIG. 2 is a structural schematic diagram II of the present invention.

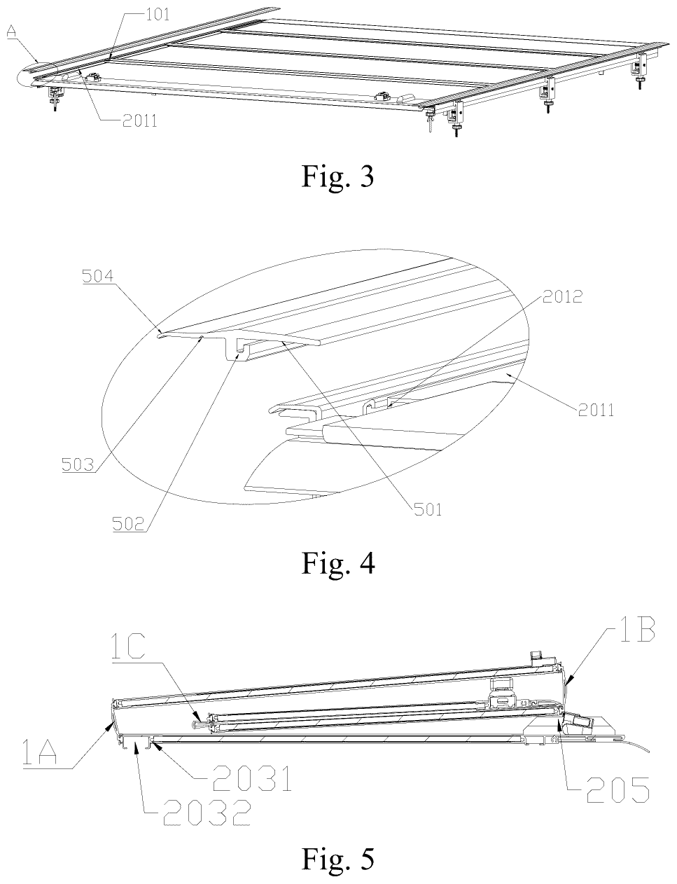

FIG. 3 is a structural schematic diagram III of the present invention.

FIG. 4 is a structural schematic diagram of part A in FIG. 3.

FIG. 5 is a schematic diagram I of the folded car cover.

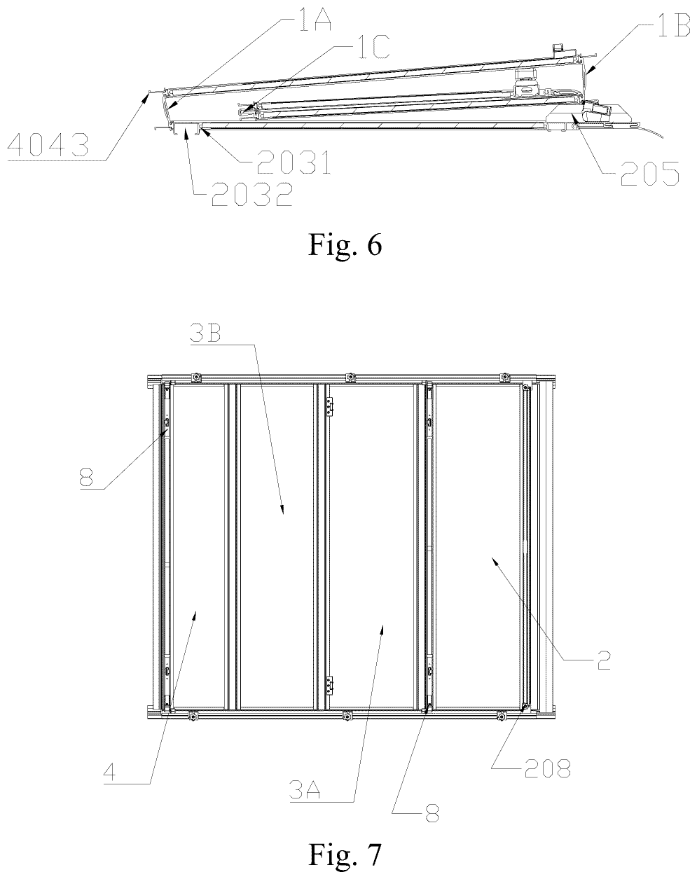

FIG. 6 is a schematic diagram II of the folded car cover.

FIG. 7 is a structural schematic diagram IV of the present invention.

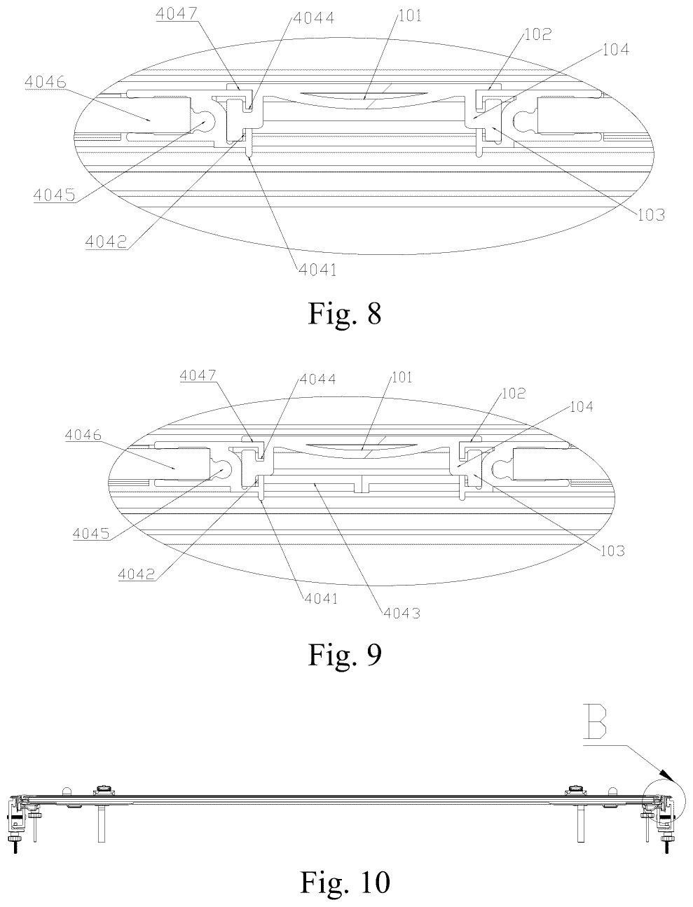

FIG. 8 is a connection schematic diagram I of the soft rotating shaft.

FIG. 9 is a connection schematic diagram II of the soft rotating shaft.

FIG. 10 is a structural schematic diagram V of the present invention.

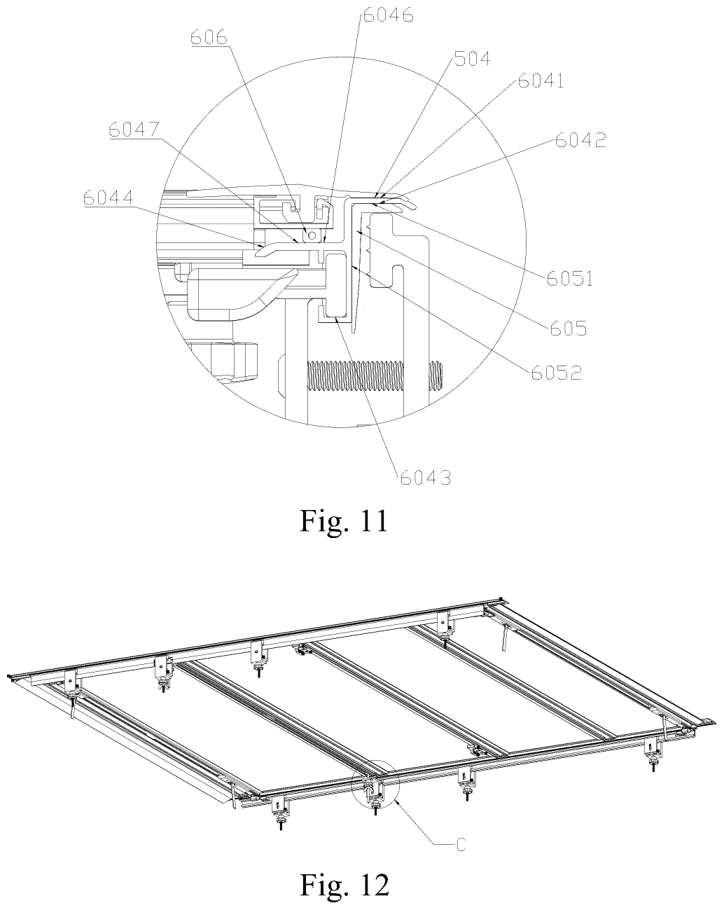

FIG. 11 is a partially enlarged view of part B in FIG. 10.

FIG. 12 is a structural schematic diagram VI of the present invention.

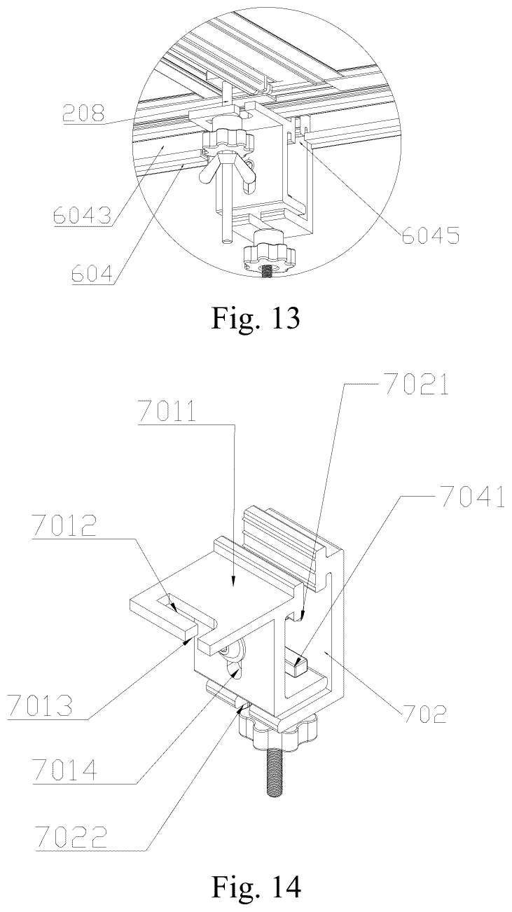

FIG. 13 is a partially enlarged view of part C in FIG. 12.

FIG. 14 is a structural schematic diagram of a clamp system of the present invention.

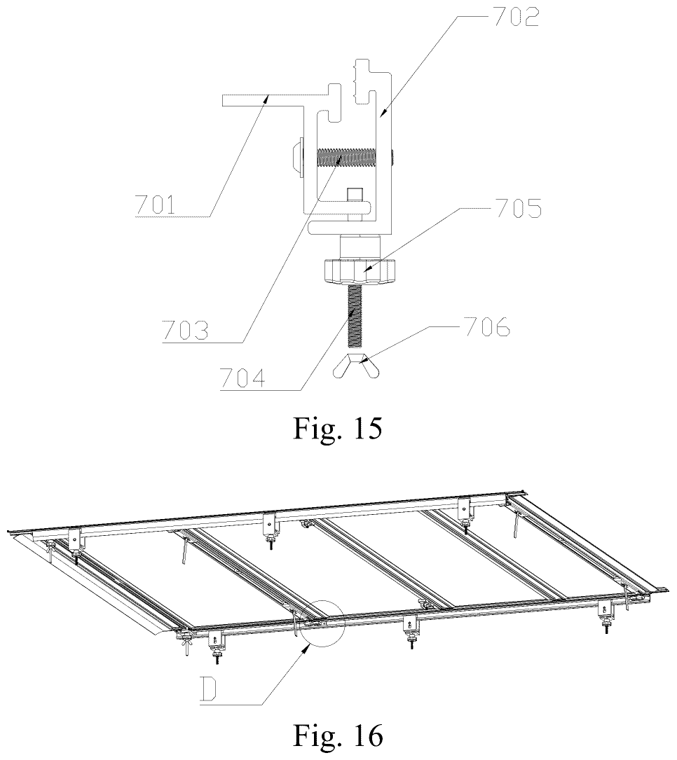

FIG. 15 is a front view of the clamp system.

FIG. 16 is a structural schematic diagram VII of the present invention.

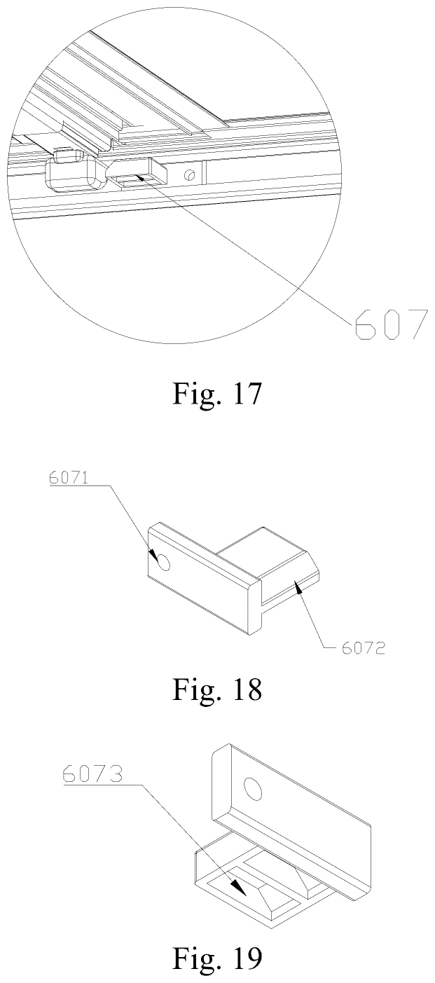

FIG. 17 is a partially enlarged view of part D in FIG. 16.

FIG. 18 is a structural schematic view of a guide rail resisting block.

FIG. 19 is another structural schematic view of the guide rail resisting block.

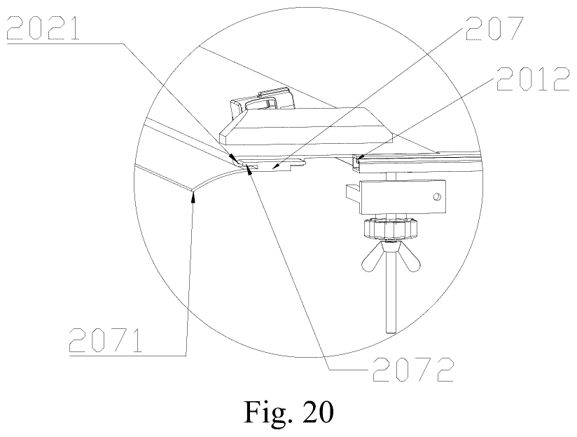

FIG. 20 is a usage schematic diagram of the guide rail resisting block.

FIGS.: 1—Soft rotating shaft; 1A—First soft rotating shaft; 1B—Second soft rotating shaft; 1C—Third soft rotating shaft; 101—Intermediate connecting bubble; 102—Pressing bar; 103—Snap-in head; 104—Snap-neck section; 2—Front plate; 201—Front plate side rail; 2011—Bonding section; 2012—Side rail bending hook; 2013—Rear protrusion; 2014—Front protrusion; 202—Front plate front bar; 2021—Front plate front bar groove; 203—Front plate rear bar; 204—Plate body; 205—Front bar support; 206—Front bar buckle; 207—Front plate rubber strip; 2071—Extension surface; 2072—Front plate rubber strip insertion head; 208—Front plate fixing rod; 2081—Threaded rod; 2082—Square head; 3A—First intermediate plate; 3B—Second intermediate plate; 3B011—Rear bar pressing rod; 3B012—Rear bar resisting rod; 4—Small plate; 401—Rear bar; 4011—Rear bar profile lower surface; 4012—Gluing groove; 402—Small plate body; 403—Small plate side rail; 404—Small plate front bar; 4041—Pressing rod; 4042—Rod groove; 4043—Resisting rod; 4044—Upper pressing head; 4045—Screw fixing hole; 4046—Plate groove; 4047—Upper Plane; 405—Rear bar rubber strip; 4051—Rear are rubber strip hole; 4052—Rear bar rubber strip insertion head; 4053—Rear bar rubber strip gluing surface; 5—Side rubber strip; 501—Gluing section; 502—Bending hook section; 503—Groove; 504—Lower pressing and bending surface; 6—Guide System; 6—Guide rail system; 601—Front bar fixing clamp; 6011—Front and rear grooves; 6012—Snap-in notch; 6013—Slide-in section; 6014—Threaded hole; 602—Plum nut; 603—Butterfly nut; 604—Guide rail; 6041—Supporting upper surface; 6042—Supporting lower surface; 6043—Guide rail groove; 6044—Lock bolt arching surface; 6045—Gluing surface; 6046—Positioning strip; 605—First guide rail rubber strip; 6051—Rubber strip top surface; 6052—Rubber strip gluing surface; 606—Second guide rail rubber strip; 607—Guide rail resisting block; 7—Clamp system; 701—Left clamp; 7011—Waisted hole; 702—Right clamp; 7021—Threaded connecting hole; 7022—Half-waisted hole; 703—Screw; 704—T-rod; 7041—Positioning head; 705—Nut; 8—Fixing lock tongue; 801—Lock tongue base; 8011—Spring arrangement compartment; 8012—Cylindrical travelling compartment; 8013—Lock tongue cavity; 802—Wire support block; 803—Lock tongue cover; 8031—Fixing screw hole; 8032—Wire hole; 804—Lock bolt; 8043—Sliding block; 8044—Decorative cover; 805—Lock bolt spring steel; 806—Wire; 807—Lock bolt cylinder; 808—Spring; 809—Cylindrical bar; 810—Pull strap.

### The Concrete Method to Carry Out

The following instruction further explains the invention's concrete implementation method.

In order to enable a clearer understanding of the objects mentioned above, features and advantages of the present invention, the invention is described in detail below in connecting with the accompanying FIG and specific embodiments. It should be noted that the embodiments of the present invention and the features in the embodiments can be combined without conflict.

The terms “first”, “second”, “third”, etc. are only used to differentiate the description and should not be construed as indicating or implying relative importance.

In the description of the invention, it should also be noted that, unless otherwise expressly specified and limited, the terms “arranged,” “installed,” “connected,” and “combined” should be understood in a broad sense. for example, it may be a fixing connecting, it can also be a detachable connecting or an integral connecting. it can be a mechanical connecting or an electrical connecting. it can be a direct connecting or an indirect connecting through an intermediate media. And it can be internal connecting within two assemblies. For those of ordinary skill in this field, specific meanings of the above terms in the present invention can be understood in specific situations.

The specific embodiments of the present invention will be described in detail below in connecting with the accompanying FIG. It should be understood that the specific embodiments described herein are intended only to illustrate and explain the present invention and not to limit it.

### Embodiment 1

As shown in FIGS. 1-7 and 13, an ultra-thin embedded rigid cover without joints includes a side rubber strip 5, a guide rail system 6, a clamp system 7, a fixing lock bolt, a plurality of cover plates, and a plurality of soft rotating shafts 1, with a gap between two adjacent cover plates 204;

The cover plate includes a front plate 2, a first intermediate plate 3A, a second intermediate plate 3B and a small plate 4, the front plate 2 and the first intermediate plate 3A, the first intermediate plate 3A and the second intermediate plate 3B, the second intermediate plate 3B and the small plate 4 are all connected by a soft rotating shaft 1, the soft rotating shaft 1 is of a flexible material or a material combining flexibility and rigidity, the plurality of flexible rotating shafts 1 have the same width and are interchangeable, the front plate 2, the first intermediate plate 3A, the second intermediate plate 3B, the small plate 4 and the soft rotating shaft 1 are connected to a side rubber strip 5 at both end, the rotating shaft 1 is provided with an intermediate connecting bubble 101, two ends of the front plate 2, two ends of the first intermediate plate 3A, two ends of the second intermediate plate 3B and two ends of the small plate 4 are connected to a side rail (the front, intermediate and small plates all with corresponding side rails), the side rail is provided with a bonding section 2011, the side rubber strip 5 is provided with a gluing section 501, the bonding section 2011 is bonded to the gluing section 501, the gluing section 501 is bonded to the soft rotating shaft 1,

The small plate 4 are both connected to a fixing lock bolt 8, the front plate 2 is connected to a front bar fixing rod 208.

The fixed lock lock bolt 8 is arbitrarily connected to the first intermediate plate 3A, the second intermediate plate 3B and the small plate 4 (arbitrarily connected herein means that the fixing lock bolt can be connected to one or more of the above mentioned plates, or it can be arbitrarily connected to any position of the above mentioned plates), the front plate 2 is connected to either a fixing lock bolt 8 or a front plate fixing rod 208 (the front plate 2 can be connected to either a fixing lock bolt 8 or a front plate fixing rod 208, by connecting only one of them. if the front plate fixing rod 208 is connected, it is necessary to arrange the front plate fixing rod 208 on the side of the front plate 2 close to the front of the car, on the other hand, if the fixing lock bolt 8 is connected, the fixing lock bolt 8 is arranged on the side of the front plate 2 close to the tail of the car).

The present invention does not set end caps at both ends of the soft rotating shaft 1, the soft rotating shaft will be directly connected to a side rubber strip on both sides, which can reduce the thickness of the car cover.

### Embodiment 2

As shown in FIGS. 1-7, and 14, an ultra-thin embedded rigid cover without joints includes a side rubber strip 5, a guide rail system 6, a clamp system 7, a fixing lock bolt, a plurality of cover plates and a plurality of soft rotating shafts 1;

The cover plate includes a front plate 2, a first intermediate plate 3A, a second intermediate plate 3B and a small plate 4, the front plate 2 and the first intermediate plate 3A, the first intermediate plate 3A and the second intermediate plate 3B, the second intermediate plate 3B and the small plate 4 are all connected to each other by a soft rotating shaft 1, the soft rotating shaft 1 is of a flexible material or a material combining flexibility and rigidity, the plurality of flexible rotating shafts 1 have the same width and are interchangeable, the front plate 2, the first intermediate plate 3A, the second intermediate plate 3B, the small plate 4 and the soft rotating shaft 1 are connected to side rubber strips 5 at both ends, the rotating shaft 1 is provided with an intermediate connecting bubble 101, two ends of the front plate 2, two ends of the first intermediate plate 3A, two ends of the second intermediate plate 3B and two ends of the small plate 4 are connected to a side rail (the front, intermediate and small plates all with corresponding side rails), the side rail is provided with a bonding section 2011, the side rubber strips 5 are provided with a gluing section 501, the bonding section 2011 is bonded to the gluing section 501, the gluing section 501 is bonded to the soft rotating shaft 1.

The small plate 4 are both connected to a fixing lock bolt 8, the front plate 2 is connected to a front bar fixing rod 208.

The fixing lock bolt 8 is arbitrarily connected to the first intermediate plate 3A, the second intermediate plate 3B and the small plate 4 (arbitrary connected herein means that the fixing lock bolt 8 can be connected to one or more of the above mentioned plates, or it can be arbitrarily connected to any position of the above mentioned plates), the front plate 2 is connected to either a fixing lock bolt 8 or the front plate fixing rod 208 (the front plate 2 can be connected to either a fixing lock bolt 8 or a front plate fixing rod 208, by connecting only one of them, if the front plate fixing rod 208 is connected, it is necessary to arrange the front plate fixing rod 208 on the side of the front plate 2 close to the front of the car, on the other hand, if the fixing lock bolt is connected, the fixing lock bolt is arranged on the side of the front plate 2 close to the tail of the car); whereby the two adjacent covers are abutting against each other when the cover is unfolded (the cover plates herein include the front plate 2, the intermediate plate, and the rear rail 401),

The pressing rod 4041 is connected with a resisting rod 4043, when the car cover is spread, the two resisting rods 4043 are pressed against each other.

### Embodiment 3

As shown in FIGS. 1-7, and 13, an ultra-thin embedded rigid cover without joints, includes a side rubber strip 5, a guide rail system 6, a clamp system 7, a fixing lock bolt, a plurality of cover plates and a plurality of soft rotating shafts 1, with a gap between two adjacent cover plates;

The cover plate includes a front plate 2, a second intermediate plate 3B and a small plate 4, the front plate 2 and the second intermediate plate 3B, the second intermediate plate 3B and the small plate 4 are connected to each other by a soft rotating shaft 1, the soft rotating shaft 1 is of a flexible material or a material combining flexibility and rigidity, the plurality of flexible rotating shafts 1 have the same width and are interchangeable, the front plate 2, the second intermediate plate 3B, the small plate 4 and the soft rotating shafts 1 are connected to a side rubber strip 5 at both ends, the soft rotating shafts 1 are provided with an intermediate connecting bubble 101, two ends of the front plate 2, two ends of the second intermediate plate 3B and two ends of the small plate 4 are all connected to a side rail, the side rail is provided with a bonding section 2011, the side rubber strip 5 is provided with a gluing section 501, the bonding section 2011 is bonded to the gluing section 501, the gluing section 501 is bonded to the soft rotating shaft 1,

The small plate 4 are both connected to a fixing lock bolt 8, the front plate 2 is connected to a front bar fixing rod 208.

The fixing lock bolt is arbitrarily connected to the second intermediate plate 3B and the small plate 4, the front plate 2 is connected to the fixing lock bolt 8 or to the front plate fixing rod 208.

The intermediate plate can be provided in a plurality of ways or only one, depending on the length of the car cover and the number of folded layers.

### Embodiment 4

As shown in FIGS. 1-7 and 13, an ultra-thin embedded rigid cover without joints includes a side rubber strip 5, a guide rail system 6, a clamp system 7, a fixing lock bolt, a plurality of cover plates and a plurality of soft rotating shafts 1.

The cover plate includes a front plate 2, a second intermediate plate 3B and a small plate 4, the front plate 2 and the second intermediate plate 3B, the second intermediate plate 3B and the small plate 4 are connected to each other by a soft rotating shaft 1, the soft rotating shaft 1 is of a flexible material or a material combining flexibility and rigidity, the plurality of flexible rotating shafts 1 have the same width and are interchangeable, the front plate 2, the second intermediate plate 3B, the small plate 4 and the soft rotating shafts 1 are connected to a side rubber strip 5 at both sides, two ends of the front plate 2, two ends of the second intermediate plate 3B and two ends of the small plate 4 are all connected to a side rail, the side rail is provided with a bonding section 2011, the side rubber strip 5 is provided with a gluing section 501, the bonding section 2011 is bonded to the gluing section 501.

The fixing lock bolt is arbitrarily connected to the second intermediate plate 3B and the small plate 4, the front plate 2 is connected to the fixing lock bolt 8 or to the front plate fixing rod 208, whereby two adjacent cover plates are abutting against each other when the cover is unfolded.

### Embodiment 5

As shown in FIGS. 1-7 and 13, an ultra-thin embedded rigid cover without joints includes a side rubber strip 5, a guide system 6, a clip system 7, a fixing lock bolt, a plurality of cover plates and a plurality of soft rotating shafts 1, with a gap between two adjacent cover plates;

The soft rotating shaft 1 includes a first soft rotating shaft 1A and a third soft rotating shaft 1C, the first soft rotating shaft 1A is of a width greater or less than the width of the third soft rotating shaft 1C, the soft rotating shaft 1 is of a flexible material or a material combining flexibility and rigidity;

The cover plate includes a front plate 2, a second intermediate plate 3B and a small plate 4, the front plate 2 and the second intermediate plate 3B are connected to each other by a first soft rotating shaft 1A, the second intermediate plate 3B and the small plate 4 are connected to each other by a second soft rotating shaft 1B, the front plate 2, the second intermediate plate 3B, the small plate 4 and the soft rotating shaft 1 are connected to a side rubber strip 5 at the ends, the soft rotating shaft 1 is provided with an intermediate connecting bubble 101, two ends of the front plate 2, two ends of the second intermediate plate 3B and two ends of the small plate 4 are connected to a side rail, the side rail is provided with a bonding section 2011, the side rubber strip 5 is provided with a gluing section 501, the bonding section 2011 is bonded to the gluing section 501, the gluing section 501 is bonded to the soft rotating shaft 1.

The fixing lock bolt is arbitrarily connected to the second intermediate plate 3B and the small plate 4, the front plate 2 is connected to the fixing lock bolt 8 or to the front plate fixing rod 208.

### Embodiment 6

As shown in FIGS. 1-7 and 13, an ultra-thin embedded rigid cover without joints includes a side rubber strip 5, a guide rail system 6, a clamp system 7, a fixing lock bolt, a plurality of covers and a plurality of soft rotating shafts 1;

The soft rotating shaft 1 includes a first soft rotating shaft 1A and a third soft rotating shaft 1C, the first soft rotating shaft 1A is of a width greater or less than the width of the third soft rotating shaft 1C, the soft rotating shaft 1 is of a flexible material or a material combining flexibility and rigidity;

The cover plate includes a front plate 2, a second intermediate plate 3B and a small plate 4, the front plate 2 and the second intermediate plate 3B are connected to each other by a first flexible rotating shaft 1A, the second intermediate plate 3B and the small plate 4 are connected to each other by a second flexible rotating shaft 1B, the front plate 2, the second intermediate plate 3B, the small plate 4 and the soft rotating shaft 1 are connected to a side rubber strip 5 at the ends, the soft rotating shaft 1 is provided with an intermediate connecting bubble 101, two ends of the front plate 2, two ends of the second intermediate plate 3B and two ends of the small plate 4 are connected to a side rail, the side rail is provided with a bonding section 2011, the side rubber strip 5 is provided with a gluing section 501, the bonding section 2011 is bonded to the gluing section 501;

The fixing lock bolt is arbitrarily connected to the second intermediate plate 3B and the small plate 4, the front plate 2 is connected to the fixing lock bolt or the front plate fixing rod 208, the two adjacent covers are abutting against each other when the cover is unfolded.

### Embodiment 7

On the basis of any one of embodiments 1-6, as shown in FIG. 19-22, the front plate 2 includes a front plate side rail 201, a front plate front bar 202, a front plate rear bar 203, a plate body 204, a front plate support 205, a front plate buckle 206, a front plate rubber strip 207 and a front plate fixing rod 208, the plate body 204 is surrounded by a front plate front bar 202, a front plate rear bar 401 and two front plate side rails, the front plate side rails 201 are provided with a rear protrusion and a front protrusion, the rear protrusion 2013 is connected to the front plate rear bar 203, the front protrusion 2014 is connected to the front plate front bar 202, the thickness of the plate body 204 is less than or equal to 10 mm.

The front bar support 205, the front bar buckle 206 and the front plate fixing rod 208 are symmetrically connected to the front plate front bar 202, the fixing lock bolt 8 is connected to the front plate rear bar 203, the front plate side rail 201 is provided with a side rail bending hook 2012, the side rubber strip 5 is provided with a bending hook section 502, the bending hook section 502 is used for hooking the side rail bending hook 2012.

The front plate 2 is connected to a guide rail system 6 through a front plate fixing rod 208, the front plate rubber strip 207 is provided with an extension surface 2071 and a front plate rubber strip insertion head 2072, the front plate front bar 202 is provided with a front plate front bar groove 2021, the front plate rubber strip insertion head 2072 is clamped with the front plate front bar groove 2021.

The front plate 2 consists of a plate body 204 surrounded by four side rails, wherein the front plate rear bar 203 is used for connecting the soft rotating shaft 1, the two front plate side rails 201 are used for connecting a side rubber strip 5 and a guide rail 604, the plate body 204 in the middle serves as a support, by providing a bending hook 502 at the side rubber strip 5, it can be fitted with the side rail bending hooks 2012 to provide a better connecting effect.

### Embodiment 8

On the basis of any of embodiments 7, as shown in FIGS. 1718, the small plate 4 includes a rear bar 401, a small plate body 402, a small plate side rail 403, a small plate front bar 404 and a rear bar rubber strip 405;

The rear bar rubber strip 405 is provided with a rear bar rubber strip hole 4051, a rear bar rubber strip insertion head 4052 and a rear bar rubber strip gluing surface 4053, the rear bar 401 is provided with a rear bar profile lower surface 4011 and an insertion groove 4012, the rear bar rubber strip insertion head 4052 is snapped into the insertion groove 4012, the rear bar rubber strip gluing surface 4053 is glued to the rear bar profile lower surface 4011.

The structure of the small plate 4 is similar to the structure of the front plate 2, both of which are constituted by the surrounding frame and the small plate body 402 in the intermediate, similarly, if the rear bar 401 profile is to be mated with the rear bar rubber strip, a corresponding snap together structure needs to be set up, and the rear bar rubber strip 405 is to be provided with the rear bar rubber strip holes 4051, which are used to increase the amount of compression.

### Embodiment 9

On the basis of any of embodiment 8, as shown in FIGS. 15-16, the side rubber strip 5 is provided with a gluing section 501, a bending hook section 502, a groove 503 and a lower pressing and bending surface 504, the gluing section 501 is used for bonding with the side rails and the intermediate rotating shaft. The groove 503 allows the glue strip to have an automatic downward pressure stress, which can increase the waterproof effect. The lower pressing and bending surface 504 also serves to increase the degree of downward pressure on the side gluing strip 5.

### Embodiment 10

On the basis of embodiment 9, the first soft rotating shaft 1A, second soft rotating shaft 1B and third soft rotating shaft 1C are interchangeable, so that the plate is able to be pressed against the front bar support 205 when the cover is flipped and fold.

The soft rotating shaft 1 includes an intermediate connecting bubble 101, a pressing bar 102, a snap-in head 103, and a snap-neck section 104;

The small plate front bar 404 includes a pressing rod 4041, a rod groove 4042, a resisting rod 4043, an upper pressing head 4044, a screw-fixing hole 4045, a plate groove 4046, and an upper plane 4047;

The pressing bar 102 is provided on the upper side of the upper plane 4047 to enhance waterproofing, the snap-in head 103 is clamped with the rod groove 4042, the pressing rod 4041 squeezes the snap-neck section 104 in cooperation with the upper pressing head 4044 after deformation, the plate groove 4046 is used to connect the plate body 204, the screw fixing holes 4045 are used to connect the side rail by screws 703.

When installing, the two snap-in heads 103 are extended into a rod groove 4042 to connect the soft rotating shaft 1. Then the pressing rod 4041 is pressed, and the pressing rod 4041 is deformed to clamp the snap-neck section 104, preventing the snap-in heads 103 from slipping out of the rod groove 4042, the pressing bar 102 is covered with the upper plane 4047, which can be bonded by glue.

The soft rotating shaft 1 is provided with an intermediate connecting bubble 101, which greatly increases the expansion and contraction elasticity of the soft rotating shaft 101, it can also play a good waterproof effect by connecting the pressing bar 102 with the upper plane 4047.

The structure of the soft rotating shaft 1 can ensure the smoothness of the car cover flipping and folding, and by setting the rod groove 4042 and the pressure bar 4041 to ensure that the two ends of the soft rotating shaft are locked in the inside of the rod groove 4042 and not easy to fall off, so as to form a stable connection with the car cover.

### Embodiment 11

On the basis of any of embodiment 10, as shown in FIG. 23, the fixing lock bolt 8 includes a lock bolt groove, a lock bolt base 801, a lock bolt cover 803, a lock bolt 804, a lock bolt spring steel 805, a steel wire 806, a lock bolt cylinder 807, a spring 808, and a cylindrical rod 809.

The lock bolt base 801 is connected with a lock bolt cover 803, the lock bolt cover is provided with a fixing screw hole 8031, the lock bolt base 801 is provided with a lock bolt cavity 8013, a spring arrangement compartment 8011 and a cylindrical travelling compartment 8012, the lock bolt cavity 8013, the spring arrangement compartment 8011 and the cylindrical travelling compartment 8012 are mutually connected, there are two lock bolt base 801, the two lock bolt base 801 are located at each end of the cover.

The lock bolt 804 includes a sliding block 8043, the sliding block 8043 is provided in the lock bolt cavity 8013.

The lock bolt cylinder 807 is located within the spring arrangement compartment 8011 and the cylinder traveling compartment 8012, one end of the lock bolt cylinder 807 is connected to the sliding block 8043 through the lock bolt spring steel 805, the other end of the lock bolt cylinder 807 is connected to a steel wire 806, the lock bolt cylinder 807 is sleeved with a spring 808, the spring 808 is located in the spring arrangement compartment 8011, the lock bolt 804 is connected to a pulling strap 810, the pulling strap 810 is located in the cylinder travelling compartment 8012, the pulling strap 810 extends out from the lock bolt cover 803.

The lock bolt 804 groove is connected with a steel wire support block 802, the steel wire 806 passes through the steel wire support block 802.

The lock bolt cover 803 is provided with a steel wire hole 8032, the steel wire 806 passes through the steel wire hole 8032.

The cylindrical travelling compartment 8012 is connected with two cylindrical rods 809, the cylindrical rod 809 is used for positioning the pulling strap 810. The lock bolt 804 is connected with a decoration cover 8044.

When installing the fixed lock bolt 8, it is necessary to first set the lock bolt base 801 at the bottom of the car cover, and then install the lock bolt 804 and other parts on the lock bolt base 801, when in use, simply pull the pulling strap 810 manually to open the lock bolt 804, and press down on the car cover after use to lock the lock bolt 804 closed.

### Embodiment 12

On the basis of any of embodiment 11, as shown in FIG. 24, the clamp system 7 includes a left clamp 701, a right clamp 702 and a T-rod 704, the left clamp 701 and the right clamp 702 are connected by screws 703, the T-rod 704 passes through the left clamp 701 and the right clamp 702, the T-rod 704 is connected with a nut 705.

The left clamp 701 is provided with a waist hole 7014, the right clamp 702 is provided with a threaded hole 7021 and a half-waist hole 7022, the screw 703 passes through the waist hole 7014 and the screw 703 hole, the T-rod 704 passes through the half-waist hole 7022.

The clamp assembly is mainly to connect the guide rail 604 to the hopper, when in use, part of the left clamp 701 extends into the guide rail groove 6043, while the right clamp 702 is located on the outer side of the hopper, the left clamp 701 and the right clamp 702 are connected by screws 703 to clamp the guide rail 604 to the car body, then longitudinally connect the T-rod 704 to achieve multi-directional positioning of the left clamp 701 and the right clamp 702, One end of the T-bar 704 is a positioning head 7041.

As the left clamp 701 is provided with front and rear grooves 7012, the front bar fixing rod 208 can be moved back and forth along the front and rear grooves 7012 after it is extended into the front and rear grooves 7012, so that it may be fine-tuned according to the position of the front bar 2.

### Embodiment 13

On the basis of embodiment 12, as shown in FIGS. 8-12, the guide rail system 6 includes a guide rail 604, the guide rail 604 includes a guide rail groove 6043, a lock bolt arcing surface 6044, a guide rail support plane and a rubber strip gluing surface 6045, the lock bolt arcing surface 6044 is located on the inner side of the guide rail 604, the guide rail support plane is located on the outer side of the guide rail 604.

The guide rail support plane includes a support upper surface 6041 and a support lower surface 6042, the support upper surface 6041 is attached to the lower pressing and bending surface 504, the first guide rail rubber strip 605 includes a rubber strip top surface 6051 and a rubber strip gluing surface 6052, the rubber strip top surface 6051 is glued to the support lower surface 6042, the rubber strip gluing surface is glued to the guide rail groove 6043.

The lock bolt arching surface 6044 is connected to the guide rail groove 6043 by a guide rail gluing surface 6047, the guide rail gluing surface 6047 is provided with a positioning strip 6046, the guide rail gluing surface 6047 is bonded with a second guide rail rubber strip 606, the second guide rail rubber strip 606 is provided along the positioning strip 6046.

As the guide rail 604 is connected to both the cargo hopper and the cover, the guide rail 604 should not only ensure the stability of the connection, but also have a certain degree of sealing, therefore, it is necessary to set up a plurality of adhesive strips in the guide rail system 6, wherein the first guide rail rubber strip 605 is set on the outer side of the guide rail 604, the clamp system 7 is loaded with the first guide rail rubber strip 605 when clamped, which can play a good anti-slip effect, the second guide rail rubber strip 606 is set up on the inner side of the guide rail 604 to play a waterproof effect and prevent rainwater from entering the hopper, in addition, the side rail rubber strip is located on the upper side of the guide rail 604, which also plays a certain waterproof effect.

Furthermore, a positioning strip 6046 is provided on the gluing surface 6045, so that the second guide rail rubber strip 606 can be arranged along the positioning strip 6046 when it is installed, avoiding problems of the status quo not being aligned.

The guide rail groove 6043 is connected to the guide rail resisting block 607, by connecting the guide rail resisting block 607 in the guide rail groove 6043, the guide rail resisting block 607 holds the lock bolt, so as to limit the lock bolt.

### Embodiment 14

On the basis of embodiment 13, the guide rail groove 6043 is connected to a front plate fixing clamp 601, the front plate fixing rod 208 includes a threaded rod 2081, one end of the threaded rod 2081 is connected to a square head 2082, which is used to clamp with the front plate front plate groove 2021, the threaded rod 2081 passes through the front plate fixing clamp 601 and connects to a plum nut 602 and butterfly nut 603.

The front bar fixing clamp 601 includes a front and rear groove 6011, a snap-in notch 6012 and a slide-in opening 6013, the slide-in opening 6012 is connected to the guide rail groove 6043, the snap-in notch 6012 is connected to the front and rear grooves 6011, the snap-in notch 6012 and the front and rear grooves 6011 are used to connect the threaded rod 208.

The front bar is connected to the guide rail 604 through the front bar fixing clamp 601, the installation of the front bar fixing clamp 601 ensures the stability of the front bar connection, one end of the front bar fixing clamp 601 is connected to the guide rail 604, followed by the front plate fixing rod 208 extends into the snap-in notch 6012, and finally the plum nut 602 and butterfly nut 603 are connected to the front plate fixing rod 208 to complete the fixing of the front plate 2.

As the front plate 2 fixing clamp is also provided with front and rear grooves 6011, the front bar fixing rod 208 can be moved back and forth along the front and rear grooves after it is extended into the front and rear grooves 6011, which allows fine-tuned according to the position of the front bar 2.

The first intermediate plate 3A and the second intermediate plate 3B are connected with the fixing lock bolt 8; or neither of the first intermediate plate 3A nor of the second intermediate plate 3B is provided with the fixing lock bolt 8;

The front plate 2 is connected with a fixing lock bolt 8, the fixing lock bolt 8 is connected to the rear part of the front plate, the front plate fixing rod 208 is connected to the front part of the front plate 2.

The invention is not limited to the above-mentioned optional embodiments. Anyone can come up with various other forms of products under the inspiration of the invention, however, regardless of any changes in its shape or structure. All technical solutions that fall within the scope defined by the claims of the present invention shall fall within the scope of protection of the invention.

1. An ultra-thin embedded rigid cover without joints, wherein, it includes a side rubber strip (5), a guide rail system (6), a clamp system (7), a fixing lock bolt (8), a plurality of cover plates and a plurality of soft rotating shafts (1), with a gap between two adjacent cover plates;
The cover plate (204) includes a front plate (2), a first intermediate plate (3A), a second intermediate plate (3B) and a small plate (4), the front plate (2) and the first intermediate plate (3A), the first intermediate plate (3A) and the second intermediate plate (3B), the second intermediate plate (3B) and the small plate (4) are all connected to each other by soft rotating shafts (1), the soft rotating shaft (1) is of a flexible material or of a material combining flexibility and rigidity, the front plate (2), the first intermediate plate (3A), the second intermediate plate (3B), the small plate (4) and the soft rotating shaft (1) are connected to a side rubber strip (5) at both ends, two ends of the front plate (2), two ends of the first intermediate plate (3A), two ends of the second intermediate plate (3B) and two ends of the small plate (4) are connected to a side rail, the side rail is provided with a bonding section (2011), the side rubber strip (5) is provided with a gluing section (501), the bonding section (2011) is bonded to the gluing section (501), the gluing section (501) is bonded to the soft rotating shaft (1);
The small plate (4) is connected with a fixing lock bolt (8), the front plate (2) is connected with a front bar fixing rod (208).

2. An ultra-thin embedded rigid cover without joints, wherein, it includes a side rubber strip (5), a guide rail system (6), a clamp system (7), a fixing lock bolt (8), a plurality of cover plates and a plurality of soft rotating shafts (1);
The cover plate includes a front plate (2), a first intermediate plate (3A), a second intermediate plate (3B) and a small plate (4), the front plate (2) and the first intermediate plate (3A), the first intermediate plate (3A) and the second intermediate plate (3B), the second intermediate plate (3B) and the small plate (4) are all connected to each other by a soft rotating shaft (1), the soft rotating shaft (1) is of flexible material or of a material combining flexibility and rigidity, the front plate (2), the first intermediate plate (3A), the second intermediate plate (3B), the small plate (4) and the soft rotating shaft (1) are connected to a side rubber strip (5) at both ends, two ends of the front plate (2), two ends of the first intermediate plate (3A), two ends of the second intermediate plate (3B) and two ends of the small plate (4) are connected to a side rail, the side rail is provided with a bonding section (2011), the side rubber strip (5) is provided with a gluing section (501), the bonding section (2011) is bonded to the gluing section (501), the gluing section (501) is bonded to the soft rotating shaft (1);
The small plate (4) is connected with a fixing lock bolt (8), the front plate (2) is connected with a front bar fixing rod (208).

3. An ultra-thin embedded rigid cover without joints, wherein, it includes a side rubber strip (5), a guide rail system (6), a clamp system (7), a fixing lock bolt (8), a plurality of cover plates and a plurality of soft rotating shafts (1), with a gap between two adjacent cover plates;
The cover plate includes a front plate (2), a second intermediate plate (3B) and a small plate (4), the front plate (2) and the second intermediate plate (3B), the second intermediate plate (3B) and the small plate (4) are connected to each other by a soft rotating shaft (1), the soft rotating shaft (1) is of a flexible material or a material combining flexibility and rigidity, the front plate (2), the second intermediate plate (3B), the small plate (4) and the soft rotating shaft (1) are connected to a side rubber strip (5) at both ends, two ends of the front plate (2), two ends of the second intermediate plate (3B) and two ends of the small plate (4) are connected to a side rail, the side rail is provided with a bonding section (2011), the side rubber strip (5) is provided with a gluing portion (501), the bonding section (2011) is bonded with the gluing section (501) the gluing section (501) is bonded with the soft rotating shaft (1);
The small plate (4) is connected with a fixing lock bolt (8), the front plate (2) is connected with a front bar fixing rod (208).

4. An ultra-thin embedded rigid cover without joints, wherein, it includes a side rubber strip (5), a guide rail system (6), a clamp system (7), a fixing lock bolt (8), a plurality of cover plates and a plurality of soft rotating shafts (1);
The cover plate includes a front plate (2), a second intermediate plate (3B) and a small plate (4), the front plate (2) and the second intermediate plate (3B), the second intermediate plate (3B) and the small plate (4) are all connected to each other by a soft rotating shaft (1), the soft rotating shaft (1) is of a flexible material or a material combining flexibility and rigidity, the front plate (2), the second intermediate plate (3B), the small plate (4) and the soft rotating shafts (1) are all connected to a side rubber strip (5), two ends of the front plate (2), two ends of the second intermediate plate (3B) and two ends of the small plate (4) are connected to a side rail, the side rail is provided with a bonding section (2011), the side rubber strip (5) is provided with a gluing portion (501), the bonding section (2011) is bonded with the gluing section (501) the gluing section (501) is bonded with the soft rotating shaft (1);
The small plate (4) is connected with a fixing lock bolt (8), the front plate (2) is connected with a front bar fixing rod (208).

5. An ultra-thin embedded rigid cover without joints, wherein, it includes a side rubber strip (5), a guide rail system (6), a clamp system (7), a fixing lock bolt (8), a plurality of cover plates and a plurality of soft rotating shafts (1), with a gap between two adjacent cover plates;
The soft rotating shaft (1) includes a first soft rotating shaft (1A) and a third soft rotating shaft (1C), the first soft rotating shaft (1A) is of a width greater than or less than the width of the third soft rotating shaft (1C), the soft rotating shafts (1) are of a flexible material or of a material combining flexibility and rigidity;
The cover plate includes a front plate (2), a second intermediate plate (3B) and a small plate (4), the front plate (2) and the second intermediate plate (3B) are connected to each other by a first soft rotating shaft (1A), the second intermediate plate (3B) and the small plate (4) are connected to each other by a second soft rotating shaft (1B), the front plate (2), the second intermediate plate (3B), the small plate (4) and the soft rotating shaft (1) are all connected to a side rubber strip (5) at both ends, two ends of the front plate (2), two ends of the second intermediate plate (3B) and two ends of the small plate (4) are connected to a side rail, the side rail is provided with a bonding section (2011), the side rubber strip (5) is provided with a gluing section (501), the bonding section (2011) is glued to the gluing section (501), the gluing section (501) is bonded to the soft rotating shaft (1);
The small plate (4) is connected with a fixing lock bolt (8), the front plate (2) is connected with a front bar fixing rod (208).

6. An ultra-thin embedded rigid cover without joints, wherein, it includes a side rubber strip (5), a guide rail system (6), a clamp system (7), a fixing lock bolt (8), a plurality of cover plates and a plurality of soft rotating shafts (1);
The soft rotating shafts (1) include a first soft rotating shaft (1A) and a third soft rotating shaft (1C), the first soft rotating shaft (1A) is of a width greater than or less than the width of the third soft rotating shaft (1C), the soft rotating shafts (1) are of flexible material or of a material combining flexibility and rigidity;
The cover plate includes a front plate (2), a second intermediate plate (3B) and a small plate (4), the front plate (2) and the second intermediate plate (3B) are connected to each other by a first soft rotating shaft (1A), the second intermediate plate (3B) and the small plate (4) are connected to each other by a second soft rotating shaft (1B), the front plate (2), the second intermediate plate (3B), the small plate (4) and the soft rotating shaft (1) are all connected to a side rubber strip (5) at both ends, two ends of the front plate (2), two ends of the second intermediate plate (3B) and two ends of the small plate (4) are connected to a side rail, the side rail is provided with a bonding section (2011), the side rubber strip (5) is provided with a gluing section (501), the bonding section (2011) is bonded with the gluing section (501), the gluing section (501) is bonded with the soft rotating shaft (1);
The small plate (4) is connected with a fixing lock bolt (8), the front plate (2) is connected with a front bar fixing rod (208).

7. An ultra-thin embedded rigid cover without joints according to any one of claims 1-6, wherein, the front plate (2) includes a front plate side rail (201), a front plate front bar (202), a front plate rear bar (203), a plate body (204), a front bar support (205), a front bar buckle (206), a front plate rubber strip (2) and a front plate fixing rod (208);
The plate body (204) is surrounded by a front plate front bar (202), a front plate rear bar (401) and two front plate side rails, the front plate side rail (201) is provided with a rear protrusion (2013) and a front protrusion (2014), the rear protrusion (2013) is connected to the front plate rear bar (203), the front protrusion (2014) is connected to the front plate front bar (202), the thickness of the plate body (204) is less than or equal to 10 mm;
The front bar support (205), the front bar buckle (206) and the front plate fixing rod (208) are symmetrically connected to the front plate front bar (202), the fixing lock bolt (8) is connected to the front plate rear bar (203), the front plate side rail (201) is provided with a side rail bending hook (2012), the side rubber strip (5) is provided with a bending hook section (502), the bending hook section (502) is used for hooking the side rail bending hook (2012);
The front plate (2) is connected to the guide rail system (6) by a front plate fixing rod (208).
The front plate rubber strip (207) is provided with an extension surface (2071) and a front plate rubber strip insertion head (2072), the front plate front bar (202) is provided with a front plate front bar groove (2021), the front plate rubber strip insertion head (2072) is clamped with the front plate front bar groove (2021).

8. An ultra-thin embedded rigid cover without joints according to any one of claims 1 to 6, wherein, the small plate (4) includes a rear rail (401), a small plate body (402), a small plate side rail (403), a small plate front bar (404) and a rear bar rubber strip (405);
The rear bar rubber strip (405) is provided with a rear bar rubber strip hole (4051), a rear bar rubber strip insertion head (4052) and a rear bar rubber strip adhesive surface (4053), the rear bar (401) is provided with a rear bar profile lower surface (4011) and an insertion groove (4012), the rear bar rubber strip insertion head (4052) is stuck into the insertion groove (4012), the rear bar rubber strip adhesive surface (4053) is bonded to the rear bar profile lower surface (4011).

9. An ultra-thin embedded rigid cover without joints according to any one of claims 1 to 6, wherein, the side rubber strip (5) is provided with a gluing section (501), a bending hook section (502), a groove (503) and a lower pressing and bending surface (504), the gluing section (501) is for bonding with the side rails and the intermediate rotating shafts.

10. An ultra-thin embedded rigid cover without joints according to any one of claims 1-6, wherein, the soft rotating shaft (1) includes an intermediate connecting bubble (101), a pressing bar (102), a snap-in head (103), and a snap-in neck section (104);
The small plate front bar (404) includes a pressing rod (4041), a rod groove (4042), an upper pressing head (4044), a screw fixing hole (4045), a snap-in plate groove (4046) and an upper plane (4047);
The pressing bar (102) is provided on the upper side of the upper plane (4047), the snap-in head (103) is clamped with the rod groove (4042), the pressing rod (4041) squeezes the snap-neck section (104) in cooperation with the upper pressing head (4044) after deformation, the snap-in plate groove (4046) is used to connect the plate body (204), the screw fixing holes (4045) are used to connect the side rails by screws (703).

11. An ultra-thin embedded rigid cover without joints according to any one of claims 2, 4 and 6, wherein, the soft rotating shaft (1) includes an intermediate connecting bubble (101), a pressing bar (102), a snap-in head (103), and a snap-in neck section (104);
The small plate front bar (404) includes a pressing rod (4041), a rod groove (4042), a resisting rod (4043), an upper pressing head (4044), a screw fixing hole (4045), a snap-in plate groove (4046) and an upper plane (4047);
The pressing bar (102) is provided on the upper side of the upper plane (4047), the snap-in head (103) is clamped with the rod groove (4042), the pressing rod (4041) is connected with the resisting rod (4043), the pressing rod (4041) squeezes the snap-neck section (104) in cooperation with the upper pressing head (4044) after deformation, the snap-in plate groove (4046) is used to connect the plate body (204), the screw fixing holes (4045) are used to connect the side rails by screws (703).

12. An ultra-thin embedded rigid cover without joints according to any one of claims 1-6, wherein, the fixing lock bolt (8) includes a lock bolt base (801), a lock bolt cover (803), a lock bolt (804), a lock bolt spring steel (805), a steel wire (806), a lock bolt cylinder (807), a spring (808), and a cylindrical rod (809);
The lock bolt base (801) is connected with a lock bolt cover (803), the lock bolt base (801) is provided with a lock bolt cavity (8013), a spring arrangement compartment (8011) and a cylindrical travelling compartment (8012), the lock bolt cavity (8013), the spring arrangement compartment (8011) and the cylindrical travelling compartment (8012) are mutually connected;
The lock bolt (804) includes a sliding block (8043), the sliding block (8043) is provided in the lock bolt cavity (8013);
The lock bolt cylinder (807) is located within the spring arrangement compartment (8011) and the cylinder traveling compartment (8012), one end of the lock bolt cylinder (807) is connected to the sliding block (8043) through the lock bolt spring steel (805), the other end of the lock bolt cylinder (807) is connected to a steel wire (806), the lock bolt cylinder (807) is sleeved with a spring (808), the spring (808) is located in the spring arrangement compartment (8011), the lock bolt (804) pulling rope is connected to a pulling strap (810), the pulling strap (810) is located in the cylinder travelling compartment (8012), the pulling strap (810) extends out from the lock bolt cover (803).

13. An ultra-thin embedded rigid cover without joints according to claim 12, wherein, the locking tongue groove is connected with a steel wire support block (802), the steel wire (806) passes through the steel wire support block (802);
The locking tongue cover (803) is provided with a steel wire hole (8032), the steel wire (806) passes through the steel wire hole (8032);
The cylindrical travelling compartment (8012) is connected with two cylindrical rods (809), the cylindrical rod (809) is used for positioning the pulling strap (810).

14. An ultra-thin embedded rigid cover without joints according to any one of claims 1-6, wherein, the clamp system (7) includes a left clamp (701), a right clamp (702) and a T-rod (704), the left clamps (701) and the right clamps (702) are connected by screws (703), the T-rod (704) passes through the left clamp (701) and the right clamp (702), the T-rod (704) is connected with a nut (705), one end of the T-rod (704) is a positioning head (7041);
The left clamp (701) is provided with a waist hole (7011), the right clamp (702) is provided with a threaded connection hole (7021) and a half-waist hole (7022), the screw (703) passes through the waist hole (7011) and the threaded connection hole (7021), the T-rod (704) passes through the half-waist hole (7022).

15. An ultra-thin embedded rigid cover without joints according to any one of claims 1-6, wherein, the guide rail system (6) includes a guide rail (604), the guide rail (604) includes a guide rail groove (6043), a lock bolt arching surface (6044), a guide rail support plane and a rubber strip gluing surface (6045), the lock bolt arching surface (6044) is located on the inner side of the guide rail (604), the guide rail support plane (604) is located on the outer side of the guide rail (604);
The guide rail support plane includes a support upper surface (6041) and a support lower surface (6042), the support upper surface (6041) is attached to the lower pressing and bending surface (504), the first guide rail rubber strip (605) includes an rubber strip top surface (6051) and a rubber strip gluing surface (6052), the rubber strip top surface (6051) is glued to the support lower surface (6042), the rubber strip gluing surface (6052) is glued to the guide rail groove (6043);
The lock bolt arching surface (6044) is connected to the guide rail groove (6043) by an adhesive surface (6045), the adhesive surface (6045) is provided with a positioning strip (6046), the adhesive surface (6045) is bonded with a second guide rail rubber strip (606), the second guide rail rubber strip (606) is provided along the positioning strip (6046). the guide rail support surface is located on the outer side of the guide rail (604).

16. An ultra-thin embedded hard cover without joints according to any one of claim 15, wherein, the guide rail groove (6043) is connected to a front plate fixing clamp (601), the front plate fixing rod (208) includes a threaded rod (2081), one end of the threaded rod (2081) is connected to a square head (2082), which is used to clamp with the front plate front plate groove (2021), the threaded rod (2081) passes through the front plate fixing clamp (601) and is connected to a plum nut (602) and butterfly nut (603).

17. An ultra-thin embedded rigid cover without joints according to claim 16, wherein, the front bar fixing clamp (601) includes a front and rear groove (6011), a snap-in notch (6012) and a slide-in opening (6013), the slide-in opening (6013) is connected to the guide rail groove (6043), the snap-in notch (6012) is connected to the front and rear grooves (6011), the snap-in notch (6012) and the front and rear grooves (6011) are used to connect a threaded rod (2081).

18. An ultra-thin embedded rigid cover without joints according to any one of claims 1-6, wherein, at least one of the first intermediate plate (3A) or the second intermediate plate (3B) is connected with a fixing lock bolt (8).

19. An ultra-thin embedded rigid cover without joints according to any one of claims 1-6, wherein, the front plate (2) is connected with a fixing lock bolt (8), the fixing lock bolt (8) is connected to the end of the front plate, the front bar fixing rod (208) is connected to the front of the front plate (2).

20. An ultra-thin embedded rigid cover without joints according to any one of claims 1-6, wherein, the profile frame around the front plate (2), the first intermediate plate (3A), the second intermediate plate (3B) and the small plate (4) are all glued to the plate, the side rails for threading the rubber strips 5 are connected to the plate by means of rivets punched at the bottom surface of the side rails.
